(19) United States
(12) Patent Application Publication
(10) Pub. No.: US 2004/0086314 A1
(43) Pub. Date: May 6, 2004

(54) Standard keyboard supporting multimedia functions

(76) Inventors: Peter Chen, Hsin Chuang City (TW); Marco Chang, Hsin Chuang City (TW)

Correspondence Address: RABIN & BERDO, P.C., 1101 14th Street, N.W., Suite 500, Washignton, DC, 20005, US

(21) Appl. No.: 10/288,302

(22) Filed: Nov. 6, 2002

(51) Int. Cl. B41J 5/08

(52) U.S. Cl. 400/472

(57) ABSTRACT

A standard keyboard includes a plurality of function keys having a second function hierarchy defined to support multimedia functions, and a setting key adapted to work with the function keys to form different key combinations. The function keys are electrically connected to a scan matrix inside the keyboard to enable conversion of a state flag of a micro central processing unit of the keyboard through interlocking of two keys and change of scan codes of the function keys, so that application programs obtained from database and application program interface under Windows may be used to run a selected multimedia function by manipulating the function keys and the setting key directly on the standard keyboard without the need of adding any new key thereto. And, an actual state of the switched keyboard is indicated by a light-emitting diode provided on the keyboard.

### BACKGROUND OF THE INVENTION

The present invention relates to a standard keyboard, and more particularly to a standard keyboard with which existing function keys thereof can be switched to hot keys to support multimedia functions without the need of adding new keys, and the switched state of the keyboard can be easily known via a monitor connected to the keyboard and a light-emitting diode (LED) provided on the keyboard.

Please refer to FIGS. 1 and 2 that are top plan views of a conventional multimedia keyboard 1 having extended keys and a conventional standard keyboard 2, respectively. As shown, the conventional multimedia keyboard 1 is obtained by adding a plurality of multimedia hot keys 11 to the conventional standard keyboard 2. There are about 18 multimedia hot keys 11, including Volume Up, Volume Dn, Mute, WWW, Record, Rewind, Close, etc. These multimedia hot keys 11 have respective scan codes that can work with application programs under Windows, so that an operator may directly manipulate the hot keys 11 on the keyboard 1 and know the provided multimedia functions on the screen of the monitor. However, adding extended hot keys 11 to the conventional standard keyboard 2 has the disadvantage of increasing the volume of the keyboard 2. Moreover, it is very expensive to add the multimedia hot keys 11 that require about two to three US dollars each.

There has also been suggested to add a key on a keyboard as a control key to switch the keyboard between a standard keyboard and a multimedia keyboard. This way still necessitates modification of molds for manufacturing the standard keyboard and is not much helpful in reducing the modification cost.

A further suggestion is to provide a Scroll Lock key or a Num Lock key on the standard keyboard that can be directly manipulated to create a plurality of control key combinations for the standard keyboard to support multimedia functions at the same time. In this suggestion, application program Resisger under Win 95 is used to detect the flag bit of the Scroll Lock key or the Num Lock key, and a specific driver is used to judge the detected flag bit before a code conversion can be proceeded. Thereafter, use the function of Win Exec 0 provided by Windows API (Application Program Interface) to substitute the path directing to a desired file and the filename argument of the application program, so that the control key combinations are able to support multimedia functions. The above-mentioned suggestion would cause some existing keys to lose their initially designed functions and is therefore not a wise way to modify the standard keyboard.

It is therefore desirable to develop a standard keyboard with which existing function keys thereof can be switched to hot keys to support multimedia functions without the need of adding new keys, and the switched state of the keyboard can be easily known via a monitor connected to the keyboard and a light-emitting diode (LED) provided on the keyboard.

### SUMMARY OF THE INVENTION

A primary object of the present invention is to provide a standard keyboard supporting multimedia functions, so that existing function keys on the standard keyboard can be switched to hot keys to support multimedia functions without the need of adding new keys, and the switched state of the keyboard can be easily known via a monitor connected to the keyboard and a light-emitting diode (LED) provided on the keyboard.

To achieve the above and other objects, the standard keyboard supporting multimedia functions according to the present invention includes a plurality of function keys having a second function hierarchy defined to support multimedia functions, and a setting key adapted to work with the function keys to form different key combinations. The function keys are electrically connected to a scan matrix formed by I/O port lines of a microprocessor inside the standard keyboard to enable conversion of state flags of a micro central processing unit inside the keyboard through interlocking of two keys and change of scan codes of the function keys, so that application programs obtained from database and application program interface under Windows may be used to run selected multimedia functions when an operator manipulate the function keys and the setting key directly on the standard keyboard to switch the function keys to multimedia hot keys. An actual working state of the switched standard keyboard is shown on a monitor connected to the keyboard and indicated by a light-emitting diode provided on the keyboard. Thus, it is no need to add any new key for the standard keyboard to support the multimedia function.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a fragmentary top plan view of a conventional multimedia keyboard having extended keys provided thereon;

FIG. 2 is a top plan view of a conventional standard keyboard;

FIG. 3 is a top plan view of a standard keyboard according to the present invention;

FIG. 4 is a connection circuit for a micro central processing unit inside the keyboard of the present invention;

FIG. 5 is a circuit scan matrix for the micro central processing unit inside the keyboard of the present invention; and

FIG. 6 is a flowchart showing steps of key scanning by the micro central processing unit inside the keyboard of the present invention.

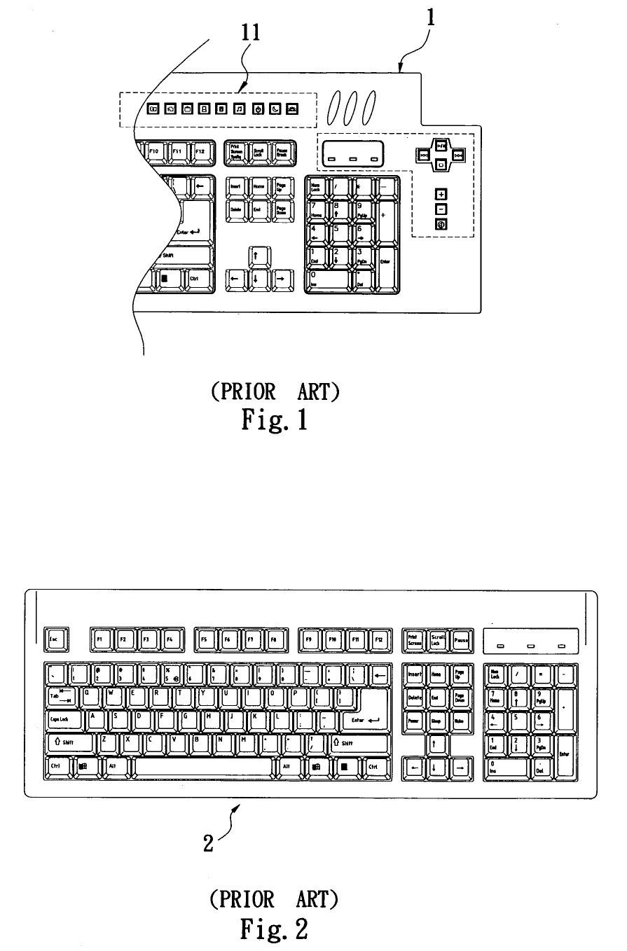

### DETAILED DESCRIPTION OF THE PREFERRED EMBODIMENTS

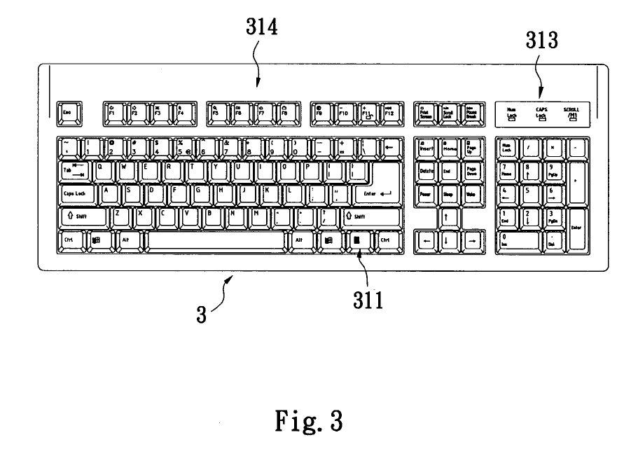

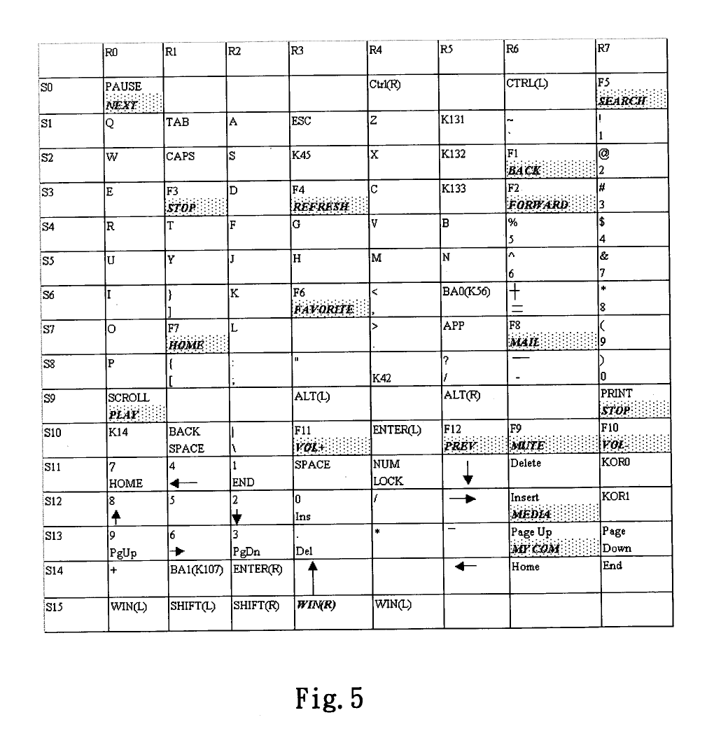

Please refer to FIGS. 3, 4, and 5 that are sequentially a top plan view of a standard keyboard 3 according to the present invention, a connection diagram for a micro central process unit inside the keyboard 3, and a circuit scan matrix for the micro central processing unit. As shown, the keyboard 3 is a two-way communicating apparatus. When a computer system, to which the keyboard 3 is connected, gives a command to the keyboard 3, the keyboard 3 has to respond to the computer system. The micro central processing unit 31 inside the keyboard 3 keeps detecting the circuit scan matrix and checking for any depressed key. An existing LED on the keyboard 3 controlled by the micro central processing unit 31 for indicating the state of Scroll Lock is changed from a mono-color LED to a dual-color M1 LED 312. An APP key (Windows Application Program Key) 311 on the standard keyboard 3 is set to a setting key that can be selectively combined with any existing function key 314 on the keyboard 3 to form any one of the following setting key combinations: APP+F1, APP+F2, APP+F3, APP+F4, APP+F5, APP+F6, APP+F7, APP+F8, APP+F9, APP+F10, APP+F11, APP+F12, APP+Esc, APP+Print Screen, APP+Scroll Lock, APP+Caps Lock, APP+Num Lock, APP+Pause. When the micro central processing unit 31 detects from the scan matrix any depressed key, it will determine whether the depressed key is the APP key 311 or not, and then detects the APP key 311 for its current state. In the case the APP key 311 is released, it is treated as a common key. However, when the APP key 311 is depressed and held, and another function key 314 is depressed at the same time, the micro central processing unit 31 would check and compare the depressed key with stored data one by one to function as a filter. For instance, when it detects that the depressed key is F12, the micro central processing unit 31 would convert the state of a marked flag in a register from “enabled” to “disabled” or from “disabled” to “enabled”. When the marked flag is disabled, the M1 LED 312 is off. And, when the marked flag is enabled, the M1 LED 312 is on to inform a user that the keyboard has now entered a second hierarchy of multimedia function defined to the depressed function key 314 (that is, F12). The user may then release the F12 key and the APP key at the same time. At this point, the micro central process unit 31 would send out a break code of the APP key 311. In the event the user is currently under Windows, a picture that would appear when a right key on a mouse is clicked would now be displayed on the screen. At this point, the keyboard 3 would send out a code of the Esc key to clear the picture that shows at clicking the right key on the mouse and thereby completes the key setting to support a specific multimedia function. Meanwhile, the micro central processing unit 31 also stops scanning. When there is another depressed key being detected, the micro central processing unit 31 would again determine whether the depressed key is the APP key or not. If not, the micro central processing unit 31 would check and compare the depressed key with stored data one by one, in order to send the keyboard 3 an appropriate keyboard scan code. The same procedures are repeated when any function key on the keyboard 3 is depressed.

In brief, the micro central processing unit 31 automatically detects from the scan matrix any depressed key and determines whether the depressed key is the setting key for switching functions of the keyboard 3. If the depressed key is the APP key 311, a recorded state of the marked flag is converted. At this point, the micro central processing unit 31 would close the scan matrix in the second hierarchy and returns to the scan matrix in the first hierarchy. In the keyboard 3 of the present invention, the function keys 314 and the hierarchy scan matrix function enables self-adjustment of scan matrix according to actual need.

To enable a user to easily find out whether the keys on the standard keyboard 3 are currently in the state supporting the multimedia functions or not, two of three existing LED's 313 on the keyboard 3 are kept unchanged while the remaining one is changed to the dual-color M1 LED 312. The user may quickly find out the current state of the keyboard 3 from the color or the on/off of the M1 LED 312.

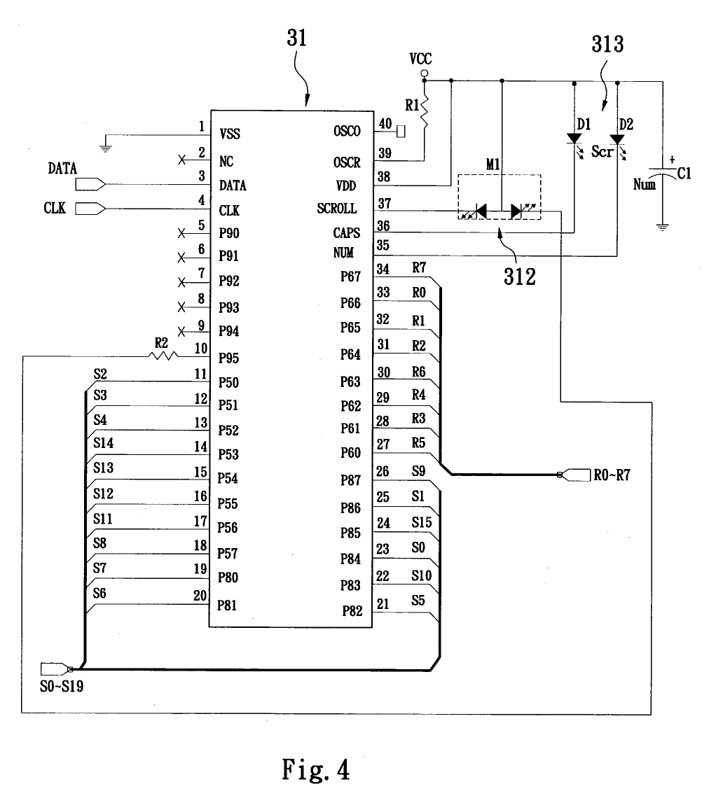

In view that a general keyboard controller is able to bear a sink current that is larger than a fanout current that can be born by the general keyboard controller, light-emitting diodes 313 having a common positive electrode are provided on the keyboard 3 for the control key combination, the Scroll Lock key, and the Num Lock key, as shown in FIGS. 3 and 4. Moreover, by switching the APP key 311 and the function keys 314 on the standard keyboard 3, the function keys 314 initially providing general functions could now provide multimedia functions. That is, the function keys 314 on the standard keyboard 3 may be switched to be multimedia control keys of Volume Up, Volume Down, Mute, Web Home, Refresh, WWW.Stop, Back, Forward, E-mail, Search, Favorites, Play, Next Track, Previous Track, Stop, Calculator, My Computer, Game, A+, A−, Zoom, etc., or maintain their original functions of Esc, F1, F2, F3, F4, F5, F6, F7, F8, F9, F10, F11, F12, Print Screen, Scroll Lock, Pause, Insert, Home, Page Up, Delete, End, Page Down, etc., or be switched to be software tool keys of Help, New, Open, Save, Replace, Bold, Spell, Bullets, Reply, Forward, Send, TaskPane, Print, Redo, Undo, Cut, Copy, Paste, Close, etc.

The function keys 314 are electrically connected to the scan matrix formed from Input/Output (I/O) port lines of a microprocessor configured inside the keyboard 3. By interlocking of two keys, it is possible to change the scan code for a depressed key. In other words, when the APP key 311 is depressed and held and another function key 314 is further depressed, the APP key 311 and the depressed function key 314 are interlocked. By “interlocking of two keys”, it means a first key is depressed and held before a second key is depressed. It is to be noted the first key should not be released before the second key has been released in order to enable the function of interlocking of two keys. For example, when the F12 key is depressed while the APP key 311 is depressed and held, the state of the state flag of the micro central processing unit would be changed. At this point, a whole group of the function keys 314, including F1, F2, F3, . . . , F11, F12, Print Screen, Scroll Lock, Page Up, etc., would be changed to function like multimedia hot keys. Icons representing different multimedia functions may be imprinted on tops of the function keys 314 to identify the multimedia function provided by each individual function key 314. By changing the key scan codes of the whole group of function keys, it is possible to execute the application programs under Windows to obtain the multimedia functions by directly manipulating corresponding control keys on the standard keyboard. And, the selected multimedia function is shown on the screen of the monitor.

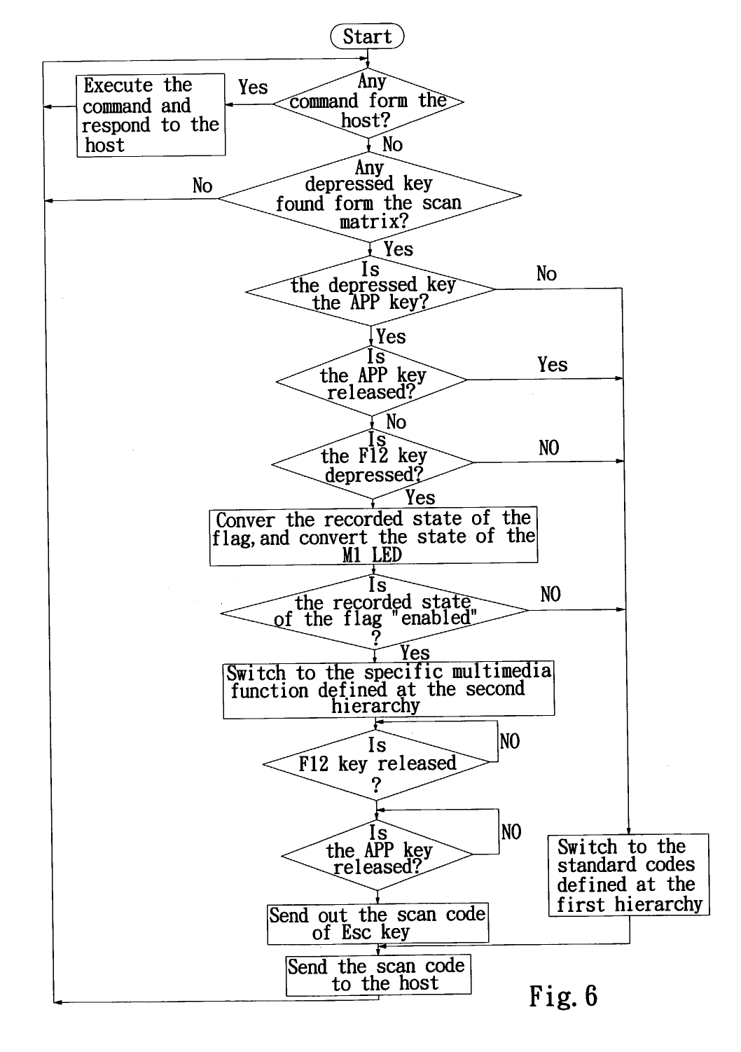

FIG. 6 is a flowchart showing steps included in the state conversion by the micro central processing unit 31. When the APP key 311 is released, a picture that usually appears when a right key on the mouse is clicked would show on the screen. At this point, the keyboard automatically sends out the key scan code of the Esc key to clear the picture. Moreover, the keyboard 3 may also work with other specific software, or use the function of Win Exec 0 provided by Windows API to substitute the path directing to the desired file and the filename argument for the application program. In this manner, an operator can manipulate the control key combinations directly on the keyboard, and the selected multimedia function is shown on the screen of the monitor.

For example, when the function keys 314 are in the state of supporting the multimedia function, and the operator depresses the multimedia hot key Player on the keyboard 3, an appropriate application program under Windows would scan and intercept the scan code that appears when the hot key Player on the keyboard is depressed, and determines whether the scan code is a hot key code or not. If it is determined from the scan code that the key depressed by the operator is indeed the multimedia hot key Player, then the appropriate application program under Windows would use the function of Win Exec 0 provided by Windows API to substitute the path directing to the file of Player and the filename argument of the application program PLAYER.EXE (bundle with Windows 95). At this point, the Player is actuated and is immediately shown on the screen of the monitor.

What is claimed is:

1. A standard keyboard supporting multimedia functions, comprising a plurality of function keys having a second function hierarchy defined to support multimedia functions, and a setting key adapted to work with said function keys to form different key combinations; said function keys being electrically connected to a scan matrix formed by I/O port lines of a microprocessor inside said standard keyboard to enable conversion of a state flag of a micro central processing unit inside said keyboard through interlocking of two keys and change of scan codes of said function keys, so that application programs obtained from database and application program interface under Windows may be used to run a selected multimedia function when an operator manipulates said function keys and said setting key directly on said standard keyboard to switch said function keys to multimedia hot keys, and an actual state of said switched standard keyboard being shown on a monitor connected to said keyboard and indicated by a light-emitting diode provided on said keyboard without the need of adding any new key on said standard keyboard.

2. The standard keyboard supporting multimedia functions as claimed in claim 1, wherein said light-emitting diode is a dual-color light-emitting diode.

3. The standard keyboard supporting multimedia functions as claimed in claim 1, wherein said key combinations formed from said setting key and said function keys include APP+F1, APP+F2, APP+F3, APP+F4, APP+F5, APP+F6, APP+F7, APP+F8, APP+F9, APP+F10, APP+F11, APP+F12, APP+Esc, APP+Print Screen, APP+Scroll Lock, APP+Caps Lock, APP+Num Lock, and APP+Pause.

4. The standard keyboard supporting multimedia functions as claimed in claim 1, wherein said function keys may be switched to be multimedia hot keys of Volume Up, Volume Down, Mute, Web Home, Refresh, WWW.Stop, Back, Forward, E-mail, Search, Favorites, Play, Next Track, Previous Track, Stop, Calculator, My Computer, Game, A+, A−, Zoom, etc., or maintain their original functions of Esc, F1, F2, F3, F4, F5, F6, F7, F8, F9, F10, F11, F12, Print Screen, Scroll Lock, Pause, Insert, Home, Page Up, Delete, End, Page Down, etc., or be switched to software tool keys of Help, New, Open, Save, Replace, Bold, Spell, Bullets, Reply, Forward, Send, TaskPane, Print, Redo, Undo, Cut, Copy, Paste, and Close.

5. The standard keyboard supporting multimedia functions as claimed in claim 1, wherein said standard keyboard is provided in a light-emitting diode indicator zone with more than one light-emitting diode indicators having a common positive electrode.

6. The standard keyboard supporting multimedia functions as claimed in claim 1, wherein said standard keyboard is adapted to work with specific software.
